(19) United States
(12) Patent Application Publication
(10) Pub. No.: US 2005/0011651 A1
(43) Pub. Date: Jan. 20, 2005

(54) Device for vaporizing a fluid, particularly a fogging fluid or extinguishing fluid

(76) Inventor: Peter Lell, Moosburg (DE)

Correspondence Address: Russell D Culbertson;Shaffer & Culbertson, Suite 420, 1114 Lost Creek Boulevard, Austin, TX, 78746, US

(21) Appl. No.: 10/478,932

(22) PCT Filed: May 29, 2002
(86) PCT No.: PCT/DE02/01992

(30) Foreign Application Priority Data
May 29, 2001 (DE) 101 26 273.6

(51) Int. Cl. A62C 35/00

(52) U.S. Cl. 169/12

(57) ABSTRACT

The invention relates to a device for vaporizing a fluid, particularly a fogging fluid or extinguishing fluid, comprising a vaporizing body that is provided with at least one vaporizing channel. The fluid or an already partially vaporized fluid in the form of wet vapor or a mixture thereof can be fed to the vaporizing channel via a feed opening. The fluid that is vaporized in an essentially complete manner escapes out of a discharge opening, whereby the cross-section of the vaporizer channel is designed so that is enlarges from the feed opening toward the discharge opening.

The invention relates to a device for vaporizing a fluid, especially a nebulizing or extinguishing fluid, with the features of the generic part of claim 1.

Devices for vaporizing a fluid can be used, e.g., to cloud a space, e.g., the cabin of a motor vehicle. Such a device can serve as theft protection, since the mist produced when an unauthorized person attempts to gain access to the vehicle or attempts to move it hinders the unauthorized person in his actions and/or generates indications of an unauthorized use of the vehicle that can be clearly recognized from the outside. In addition, a device for vaporizing a fluid can, when appropriately designed, also be used to extinguish a fire.

It is necessary for both uses that the vaporizing device supply a sufficient amount of vapor in a relatively short time. Moreover, it is desirable in many instances that the vaporizing device have a small size.

DE 196 42 574 A1 discloses a nebulizing cartridge in which a heating-body housing filled with a thermite mixture is inserted into the housing of the nebulizing cartridge. The heating-body housing has ribs on its outer circumference in order to make possible the best possible thermal transition from the heating-body housing to the fluid to be vaporized, which is present in the substantially annular space between the inner wall of the cartridge housing and the outer wall of the heating-body housing. Several outlet openings are provided in the cover of the cup-shaped cartridge housing, through which the generated vapor exits after activation of the thermite mixture. In addition, DE 196 42 574 A1 describes an embodiment in which the heating-body housing is surrounded by a vaporizer conduit that can be formed by a tube helically surrounding the heating-body housing, or that can be cast into a jacket surrounding the heating-body housing.

EP 0878 242 A2 describes similar devices for vaporizing and/or nebulizing a liquid. For example, FIGS. 8-10 show an embodiment in which the outer wall of a heating-body housing filled with a thermite mixture has one or more grooves that form one-or more vaporizer conduits by contacting the inner wall of an annular cooling body. These vaporizer conduits have the purpose of further drying the vaporized fluid that is supplied to the vaporizer conduits from an annular chamber surrounding the cooling body, in which chamber the generation of a wet vapor takes place. Supply of the wet vapor to the vaporizing conduits takes place via a throttle formed by a bore with a rather small diameter. This limits the mass flow at the entrance of a vaporizer conduit. This is necessary in order to avoid a compression shock that might be produced, based on the constant cross section of the vaporizer conduit over its length, as a consequence of the further heating and therewith of the volumetric expansion of the vapor to be dried if the vapor to be dried or the fluid to be vaporized were supplied to the vaporizer conduit via its completely open cross section.

The invention has the basic problem, starting from this state of the art, of creating a device for vaporizing a fluid, in particular a nebulizing fluid, that has a small size and at the same time makes it possible to produce vapor with a large mass flow.

The invention solves this problem with the features of claim 1.

The invention starts with the recognition that a vaporizer conduit with a cross section that widens out from the supply opening in the direction of the exit opening achieves a utilization of the vaporizer cross section that is substantially improved by comparison to vaporizer conduits with a constant cross section. This takes into account the greater space requirement of the hot vapor that is becoming hotter. Thus, a reduction of the space requirement results by comparison to known devices with a constant conduit cross section, as a consequence of which smaller structural forms are possible.

In one embodiment of the invention the vaporizer conduit can have several zones with a constant cross section for each wherein the cross section of the zones increases in the direction of the exit opening. Such an embodiment does not assure an optimal utilization of the conduit cross section, but does make possible a very simple manufacture of the vaporizer body.

In another embodiment the vaporizer conduit has one or more areas with a continuously increasing cross section. This results, by comparison to the previously described embodiment, in a further improved utilization of the conduit cross section and of the surface of the vaporizer conduit as regards the thermal transfer to the fluid to be vaporized and to the wet vapor to be dried or vaporized more completely.

In one embodiment of the invention the vaporizer body comprises a first element in whose inner or outer wall at least one groove-shaped recess is provided for forming at least one vaporizer conduit. The first element can be designed as a hollow element, preferably as a hollow cylinder. At least one vaporizer conduit with a predetermined length is formed in combination with a second element comprising a wall cooperating with the inner wall or the outer wall of the first element such that a seal of the one or more groove-shaped recesses is formed. Of course, groove-shaped recesses can also be provided in a given wall of the second element that form, together with the recesses in the corresponding wall of the first element, a vaporizer conduit with correspondingly enlarged cross section. In a corresponding manner a groove-shaped recess forming a vaporizer conduit can also be provided only in the particular wall of the second element.

In a further embodiment of the invention the cooperating walls of the first and of the second element can form a predetermined small angle with the longitudinal axis, preferably in a range of 0.1 to 5°, so that so that when the two elements are inserted into one another high radial forces effecting sealing of the conduit result even at relatively low axial forces, and good thermal transmission is reliably achieved without soldering or welding.

In one embodiment of the device of the invention a heat-producing and/or heat-storing device is provided directly bordering on the inner or outer wall of the vaporizer body, creating a good heat-conducting transition from the heat-producing and/or heat-storing device to the vaporizer body. The heat-producing and/or heat-storing device can be designed as a pyrotechnic heating device comprising a pyrotechnic heating mixture or a thermite mixture. In this manner a controllably activatable device for vaporizing the fluid can be realized that produces a large amount of vapor in a short time.

In another embodiment of the invention the heat-producing and/or heat-storing device can comprise a heat-storage medium, e.g., a saline solution, oil or, e.g., a metallic heat-storage medium that is solid at room temperature and can be volatilized by supplied energy. The heat-storage medium can be supplied with thermal energy from an external device. If a metallic heat-storage medium is selected, e.g., aluminum, brass or a solder, a maintenance temperature can be achieved at the desired vaporization temperature by using a suitable alloy.

According to an embodiment of the invention the vaporizer body and the heat-producing and/or heat-storing device can be designed as an integrated cartridge, and at the same time the vaporizer body is designed as a container for receiving the heat-producing and/or heat-storage medium. This results in a simple and economical manufacture of the device.

Other embodiments result from the subclaims.

The invention is described in the following using as examples embodiments shown in the drawings.

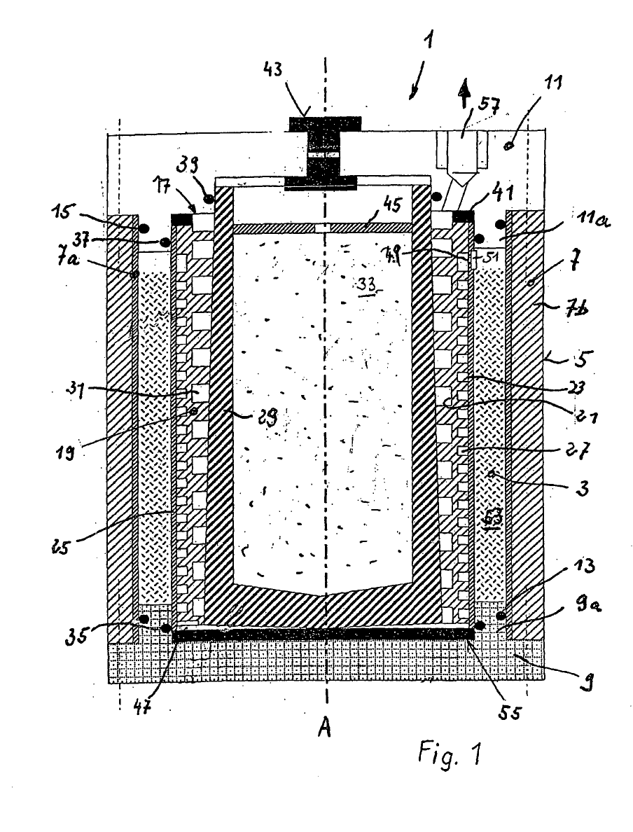

FIG. 1 shows a first embodiment of a device for vaporizing a fluid, in longitudinal section.

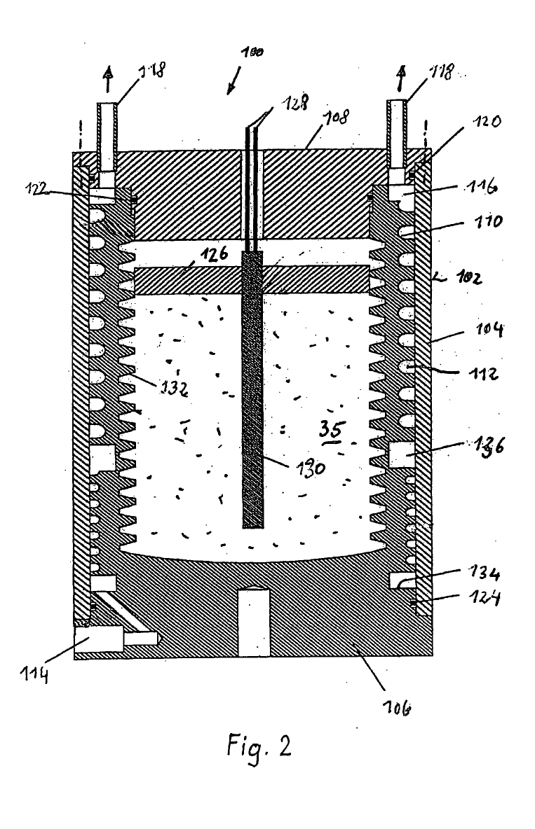

FIG. 2 shows another embodiment of the invention for vaporizing a fluid as an integrated cartridge.

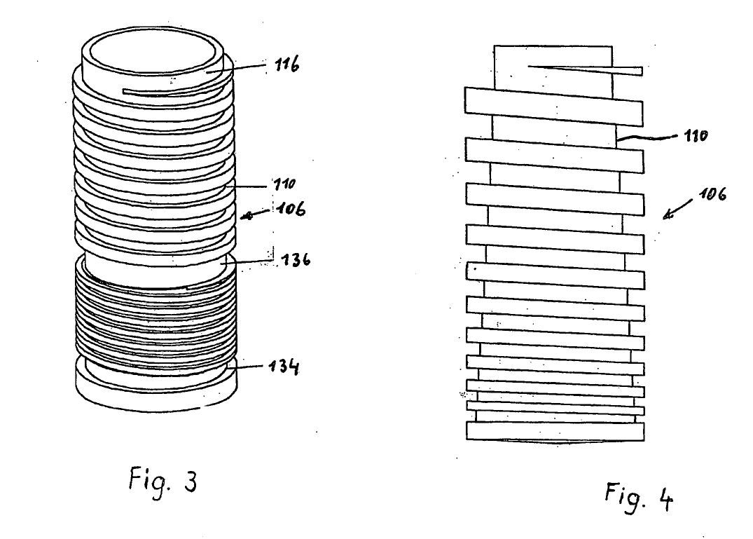

FIG. 3 shows an oblique view of a tubular element for realizing a vaporizer body according to FIG. 2.

FIG. 4 shows another embodiment of an element for realizing a vaporizer body with a vaporizer conduit that widens out continuously.

Device 1 for vaporizing fluid 3, shown in FIG. 1, comprises housing 5 consisting of hollow cylindrical wall part 7, bottom part 9 and cover part 11. Wall part 7 can consist, as FIG. 1 shows, of inner part 7a, e.g., of high-grads steel, and outer part 7b connected to it and consisting, e.g., of a short-term temperature-stable plastic. Wall part 7 can be adhered to or pressed against bottom part 9, which can also consist of plastic. For this purpose, bottom part 9 can comprise annular elevation 9a. In addition, sealing element 13, e.g., in the form of an O-ring, can be provided for creating a seal between the outer wall of annular elevation 9a and the inner wall of wall part 7. A threaded coupling, shown in dotted lines in FIG. 1, can also be provided (if necessary, in addition) for connecting wall part 7 to bottom part 9. Cover part 11 can be connected in the same manner as bottom part 9 to wall part 7. Cover part 11 can be designed substantially like bottom part 9 and comprise a circumferential annular elevation 11a. Another sealing element 15, e.g., in the form of an O-ring, can be provided for creating a seal between the outer wall of annular elevation 11a and the inner wall of wall part 7. Also, wall part 7 and bottom part 9 or wall part 7 and cover part 11 can be designed as one piece.

Heating cartridge 17 is provided in the interior of housing 5 and comprises a first, preferably substantially hollow-cylindrical, element 19 comprising respective groove-shaped recesses 21 and 23 in its inner and in its outer wall. The first element 19 consists of a material that is a good heat conductor, and is sufficiently temperature-stable, e.g., aluminum.

A second element 25 that can be designed, e.g., as an aluminum tube, is provided on the outer wall of first element 19. The inside diameter of aluminum tube 25 is selected such that it substantially matches the outside diameter of first element 19, and that a sufficient sealing action results between the two parts. A sealed vaporizer conduit 27 is produced in this manner.

A third, cup-shaped element 29 whose outside diameter substantially matches the inside diameter of first element 19 is provided inside first element 19. This achieves sealing of groove-shaped recess 21 when the third element is set into the first element, so that another vaporizer conduit 31 is formed in this manner.

As FIG. 1 shows, the outer wall of the third cup-shaped part 29 in FIG. 1 can have an upwardly decreasing diameter. In other words, the outer wall of third element 29 corresponds to the shape of an upwardly tapering conical section. In a corresponding manner the inner wall of first element 19 is designed such that the inside diameter increases towards the bottom, as FIG. 1 shows. Thus, the tangents to the inner wall of first element 19 and to the outer wall of third element 29 that have no radial component form a relatively small angle with axis A of heating cartridge 17 and of device 1 that is preferably in a range of 0.1° to 5°. In this way, high radially acting sealing forces between the facing surfaces can be produced when third, cup-shaped element 29 is inserted into first element 19 even with the production of a slight axial insertion force.

Of course, second element 25 can be connected in the same manner to the first element. However, the connection of these two elements can also be effected by adhesion, shrinking-on, soldering, welding, or the like in the framework of a solid, non-separable connection. The advantage of the previously described connection of first part 19 to third part 29 via appropriately inclined surfaces is that third element 29 can be detachably connected to first element 19. If third element 29 serves, as shown in FIG. 1, to receive a pyrotechnic material or a thermite mixture 33, third element 29 can thus be simply and economically replaced by a new element after onetime actuation of material 33 producing thermal energy.

Heating cartridge 17 is fixed in housing 5 by being held by its lower end in annular elevation 9a of bottom part 9. Heating cartridge 17 is fixed in its upper area in the same manner by cover part 11, wherein the respective upper areas of second element 25 and of third element 29 are held in corresponding recesses or their inner walls in cover part 111. Other sealing elements 35, 37, 39 can be provided for a seal between the inner wall of annular elevation 9a or annular elevation 11a and the outer wall of second element 25 as well as between the inner wall of a receiving socket for third element 29 in cover part 11 and the outer wall of third element 29.

Another sealing element 41 shaped like a ring disk can be provided between the upper end faces of first element 19 and second element 25 and the upper inside wall of cover part 11. The upper side wall of cover part 11 loads the first and the second element 19, 25 of heating cartridge 17 in the axial direction via this sealing element 41 so that the desired radial sealing forces are produced between the outer wall of third element 29 and the inner wall of first element 19. The receiving socket for the upper area of third element 29 in cover part 11 is designed such that a loading of the upper end face wall of third element 29 only occurs after first element 19 has been pushed far enough onto third element 29 that sufficiently high radial sealing forces are produced.

Such a securing of first element 19 and of third element 29 can of course also be achieved if third element 29, viewed in the axial direction, is designed to be inversely conical. In this instance first element 19 can rest on bottom part 9 and third element 29 can be pressed into first element 19 by cover part 11.

Furthermore, electrode passage element 43 is provided in cover part 11 through which electrodes (not shown) are run into the interior of third element 29, these electrodes extending far enough into the area filled with the pyrotechnic or thermite mixture 33 that activation or ignition of the material is assured. For this purpose the electrodes can be connected via a heating wire or heated filament extending into material 33 so that when current flows through the electrodes the heating wire is heated until it glows and ignites pyrotechnic or thermite mixture 33. Instead of the heating wire or heated filament an element can also be used that generates a plasma when current flows through. This is suitable, e.g., to ignite a thermite mixture. The inner space of third element 29 is as a rule not completely filled with material 33. In order to protect cover part 11 from the combustion products the partial area of the inner space is delimited by disk element 45. Element 45 can be fixed, e.g., by being pressed in, adhered in or snapped into the inner wall of thlrd element 29. The disk element preferably consists of steel or copper.

The lower front side of third element 29 is designed such that the area adjacent to axis A projects beyond the lateral areas (downward in FIG. 1). Accordingly, annular space 47 remains free when third element 29 and heating cartridge 17 are inserted into housing 5, this annular space establishing a communication between vaporizer conduits 27, 31. For this purpose, groove-shaped recesses 27, 31 are designed such that appropriate openings empty into annular space 47 on the lower front side of first element 19, and both recesses simply end at the lower end of element 19.

As FIG. 1 shows, at least one supply opening 49 that is closed by element 51 in a membrane-like manner is provided in second element 25 in the upper area of annular recess 23 and of vaporizer conduit 27.

In this manner, after the activation of material 33 producing thermal energy in the interior of third element 29 of heating cartridge 17, the thermal energy produced is transmitted via the wall of third element 29 to first element 19 and from the latter via second element 25 to fluid 53 to be vaporized that was received in the annular space between the inner wall of wall element 7 and the outer wall of second element 25 of heating cartridge 17 in housing 5.

After the beginning of supply of the thermal energy to fluid 53, the fluid is at first heated or vaporized until the pressure exceeds a predetermined value that causes closure element 51 to burst. Fluid 53 or a suitable wet vapor or a mixture thereof subsequently enters vaporizer conduit 27 via supply opening 49. During its passage through vaporizer conduit 27 the fluid is heated further or vaporized further. After it has passed through helical vaporizer conduit 27 the fluid/vapor mixture or a still relatively wet vapor enters into the lower opening of vaporizer conduit 31.

It should be mentioned at this point that a sealing material or thermal insulation material 55, e.g. in the form of a sealing disk, can of course be provided between the bottom-side end wall of third element 29 and the surface of bottom part 9 facing it.

To the extent that vaporizer conduit 27 has a constant conduit cross section between supply opening 49 and the bottom-side exit opening, vaporizer conduit 31 is designed such that its conduit cross section expands continuously in the direction from its bottom-side supply opening to the exit opening connected to exit opening 57 in cover part 11. In this way, as the vaporization state of fluid 53 becomes more and more complete, its increased volumetric requirement is taken into account. A compression shock that might lead to a “blockage” of vaporizer conduit 31 is reliably avoided in this manner. The cross section of the conduit is preferably selected such that at each point of conduit 31 (viewed over its length) the cross section of the conduit in a differential element of length is selected such that the differential volume is adapted to the volume of the vaporized fluid contained in it at the prevailing temperature and prevailing pressure.

Of course, vaporizer conduit 27 could also already be designed with a widening cross section.

The formation of a vaporizer conduit in the inner wall and outer wall of first element 19 results in the advantage of a sufficiently long vaporizer conduit (with a correspondingly large surface for the transmission of heat) with a small overall height at the same time. Furthermore, supply opening 49 can be selected in an area located above the liquid level in the case of an incomplete filling of the annular space with fluid 53 to be vaporized. This applies at least when device 1 shown in FIG. 1 is used in the upright position. The direct entrance of non-vaporized fluid 53 into vaporizer conduit 27 is avoided in this manner.

FIG. 2 shows another embodiment of a device for vaporizing a fluid that is designed essentially only as a heating cartridge similar to heating cartridge 17 of FIG. 1. Device 100 shown in FIG. 2 has a housing 102 which comprises wall part 104, cup-shaped part 106 engaging with it, and cover part 108. Cup-shaped part 106 comprises helical, groove-shaped recess 110 in its outer wall, this recess being divided along its path into two areas with different cross sections.

The outer wall of cup-shaped part 106 cooperates for its part in a sealing manner with the inner wall of wall part 104 pushed onto it, so that tight vaporizer conduit 112 is produced that is designed in accordance with the path of groove-shaped recess 110. Radial supply opening 114 is designed in the bottom area of cup-shaped part 106, this opening communicating with vaporizer conduit 112 or its first section with a smaller cross section. In the upper area of the wall of cup-shaped part 106, vaporizer conduit 112 opens out into annular space 116 that communicates with several exit openings 118 formed in cover part 108. Cover part 108 is connected in a sealing manner to wall part 104 and cup-shaped part 106. In order to create a seal, sealing elements 120, 122 can be provided between an outer wall of cover part 108 and the inner wall of wall part 104 or between an outer wall of an area of wall part 104 engaging into cup-shaped part 106 and between the inner wall of cup-shaped part 106. In the same manner, wall part 104 can be connected in its lower area by another sealing element 124, provided between the inner wall of wall part 104 and between the outer wall of cup-shaped part 106, in a sealing manner to cup-shaped part 106. Just as in the embodiment according to FIG. 1, a part of the inner space of cup-shaped part 106 delimited by protective element 126 is filled with an activatable, heat-producing material 35, e.g., a pyrotechnic mixture or thermite mixture. Again, two electrodes 128 (sealed in a manner that is not shown) are run through cover part 108 and connected to activating device 130 for activating material 35 that produces thermal energy. In the simplest case, activating device 130 can be a heating wire.

Of course, device 100 shown in FIG. 2 can also be used as a heating cartridge in a device similar to device 1 in FIG. 1. For this purpose, e.g., supply opening 114 could be appropriately blocked so that the fluid to be vaporized does not enter into vaporizer conduit 112 until a predetermined pressure has been exceeded after bursting of the closure element. However, the fluid to be vaporized can be supplied to supply opening 114 with the appropriate pressure in any other manner desired, e.g., from an external storage container.

Conversely, the inner wall of third element 29 of the embodiment in FIG. 1 can of course also be provided with structure 132 shown in FIG. 2 that enlarges the surface of the element concerned for improving the heat transfer. For example, structure 132 can comprise ribs in the inner wall of concerned element 29 or 106.

FIG. 3 shows an oblique view of cup-shaped element 106 in which the two areas of annular groove 110 that have different cross sections and define vaporizer conduit 112, can be better recognized. The lower area, shown in FIG. 3, starts from annular recess 134 communicating, as FIG. 2 shows, with radial supply opening 114. The connection of the first area of groove-shaped recess 110 with a smaller cross section to the second area with a larger cross section takes place for its part via annular area 136.

Annular areas 134, 136 are essentially provided in order to facilitate the manufacturing process.

FIG. 4 shows another embodiment of a cup-shaped element 106 in which, however, annular recess 110 is designed with a continuously increasing cross section. This variant naturally represents, from the physical standpoint, a better selection since the cross section of the vaporizer conduit being produced can be adapted at every point of its (helical) length to the particular differential volume of the vapor.

In conclusion, it is pointed out that all features described above only in combination with one or the other embodiment can of course also be used, to the extent feasible, with the other embodiment.

In both instances, instead of a heat-producing material such as a pyrotechnic mixture or thermite mixture, a purely heat-retaining material (or also a combination of both possibilities) can be used. In the case of a purely heat-retaining material, it is necessary to supply external energy. For example, a heating device could be provided in the interior or also externally that introduces thermal energy into the heat-retaining material.

1. A device for vaporizing a fluid, especially a nebulizing or extinguishing fluid,
a) with a vaporizer body in which at least one vaporizer conduit is formed which can be supplied via a supply opening with the fluid, or an already partially vaporized fluid in the form of wet vapor, or a mixture of both, and wherein the substantially completely vaporized fluid escapes from an exit opening, characterized in that
b) the cross section of the vaporizer conduit increases from the supply opening in the direction of the exit opening.

2. The device according to claim 1, characterized in that the vaporizer conduit comprises several areas with a constant cross section and that the cross section of the areas increases in the direction of the exit opening.

3. The device according to claim 1 or 2, characterized in that the vaporizer conduit comprises one or more areas with a continuously increasing cross section.

4. The device according to one of the preceding claims, characterized in that the vaporizer conduit comprises a first element in whose inrer and/or outer wall at least one groove-shaped recess is provided for forming one or more vaporizer conduits.

5. The device according to claim 4, characterized in that the first element is designed as a hollow element, preferably as a hollow cylinder.

6. The device according to claim 4 or 5, characterized in that the vaporizer conduit comprises at least one second element comprising a wall cooperating with the inner wall or the outer wall of the first hollow element such that it seals the one or more groove-shaped recesses in order to form the one or more vaporizer conduits.

7. The device according to claim 6, characterized in that the cooperating walls of the first and of the second element form a predetermined small angle with the longitudinal axis, preferably in a range of 0.1° to 5°.

8. The device according to one of the preceding claims, characterized in that a heat-producing and/or heat-storing device is provided directly bordering on the inner or outer wall of the vaporizer body, creating a good heat-conducting transition from the heat-producing and/or heat-storing device to the vaporizer body.

9. The device according to claim 8, characterized in that the heat-producing and/or heat-storing device is designed as a pyrotechnic heating device comprising a pyrotechnic heating mixture or a thermite mixture.

10. The device according to claim 8, characterized in that the heat-producing and/or heat-storing device comprises a heat-storage medium, preferably a saline solution, oil or e.g., a metallic heat-storage medium that is solid at room temperature and can be volatilized by supplied energy.

11. The device according to one of claims 8 to 10, characterized in that the heat-producing and/or heat-storing device is arranged inside the vaporizer conduit.

12. The device according to one of claims 8 to 11 characterized in that the vaporizer conduit and the heat-producing and/or heat-storing device are designed as an integrated cartridge, and that the vaporizer body is designed at the same time as a container for receiving the heat-producing and/or heat-storage medium.
